(19) United States
(12) Patent Application Publication
(10) Pub. No.: US 2010/0007572 A1
(43) Pub. Date: Jan. 14, 2010

(54) DUAL-POLARIZED PHASED ARRAY ANTENNA WITH VERTICAL FEATURES TO ELIMINATE SCAN BLINDNESS

(75) Inventors: Anthony M. JONES, Palm Bay, FL (US); Christopher TRENT, Palm Bay, FL (US)

Correspondence Address: ALLEN, DYER, DOPPELT, MILBRATH & GILCHRIST, 255 S ORANGE AVENUE, SUITE 1401, ORLANDO, FL, 32801, US

(73) Assignee: Harris Corporation, Melbourne, FL (US)

(21) Appl. No.: 11/750,624

(22) Filed: May 18, 2007

(51) Int. Cl. H01Q 21/26; H01Q 9/28; H01P 11/00

(52) U.S. Cl. 343/798; 343/795; 29/600

(57) ABSTRACT

A phased array antenna includes a substrate and an array of antenna unit cells formed on the substrate. Each antenna unit cell comprises first and second sets of coupled dipole antenna elements that are orthogonal to each other and provide dual polarization. A member is positioned at each antenna unit cell between each of the dipole antenna elements in each polarization to eliminate scan blindness without reducing broadside (non-scanned) array gain.

### FIELD OF THE INVENTION

The present invention relates to the field of communications, and more particularly, the present invention relates to phased array antennas.

### BACKGROUND OF THE INVENTION

Lightweight phased array antennas having a wide frequency bandwidth and a wide scan angle can be economically manufactured and conformally mounted on a surface, such as a nose cone of an aircraft. Examples of such antenna include a current sheet array (CSA) formed of capacitively-coupled dipole elements embedded in dielectric layers above a ground plane. The capacitors often are formed as interdigitated “fingers.” The coupling capacitance between dipole elements can be increased by lengthening the capacitor “digits” or “fingers,” which results in additional bandwidth for the antenna. An example of this type of structure is disclosed in commonly assigned U.S. Pat. No. 6,512,487 to Durham, the disclosure which is hereby incorporated by reference in its entirety.

Often this type of phased array antenna is formed as a large array, often with subarrays, and operable in the 2.0 through 18.0 GHz range. They can be constructed from different modules with separate array panels, for example, each about 12×18 inches and forming an antenna aperture. They can be constructed with an interdigitated assembly of various beam former components, subarray beam formers, transmit/receive modules and associated components, with connections that are ribbon bonded to antenna feed portions and associated legs extending outward therefrom. The antenna elements form the dipoles. As a result, these phased array antenna structures have an array of tightly packed and closely spaced dipole elements connected to neighboring dipole elements through capacitor coupling, as set forth in the above-identified and incorporated by reference '487 patent. The antenna can have dual polarization by using horizontal and vertical dipole elements and solder connections at feed points. The capacitive coupling between the electrically small dipole elements imparts a broadband performance, and can be formed using interdigitated or in some cases end-coupled capacitor elements. Edge coupling may also be used.

Tightly-coupled arrays, such as a Current Sheet Array (CSA), require a small array lattice to avoid scan anomalies. A CSA typically has capacitively-coupled antenna dipole elements embedded in dielectric above a ground plane. A small array lattice increases element density and parts count such as cost, weight, power, and thermal control. In many cases, the phased array lattice is constrained to a size which is larger than optimum due to manufacturing limitations and usage of existing RF modules. Severe impedance mismatch causes scan blindness for certain scan angles if the array lattice is greater than one-half (½) wavelength. For example, in one phased array antenna design with an array lattice greater than one-half wavelength, the element pattern null correlates to an array scan blindness at 55°. The array gain is significantly degraded at these “blind” angles and the severe impedance mismatch at the antenna terminals can be problematic for a transmit system.

The current state of the art does not permit the CSA to be used for wide-angle scanning applications in which a scan blindness occurs due to the array lattice approaching or exceeding one-half (½) wavelength. The array lattice is set by a required scan volume and high end of the operating bandwidth.

### SUMMARY OF THE INVENTION

A phased array antenna includes a substrate and an array of antenna unit cells formed on the substrate. Each antenna unit cell comprises first and second sets of coupled dipole antenna elements that are orthogonal to each other and provide dual polarization. A vertical member, such as formed as a metallic member, is positioned at each antenna unit cell between each of the dipole antenna elements in each polarization to eliminate scan blindness without reducing the broadside (non-scanned) array gain created by cavity effects.

Each member can be formed as a rib member which extends vertically from the ground plane. Each member can also be formed as a vertically extending pin that could be arranged in complementary pairs. The height of each vertical member is determined by the frequency at which the scan blindness occurs.

A substrate and array of antenna dipole antenna elements form a current sheet array. Each dipole antenna element is formed as a medial feed portion and a pair of legs extending outwardly therefrom. Adjacent legs of adjacent dipole antenna elements are formed as respective spaced apart end portions forming a gap between respective end portions. The respective spaced apart end portions of adjacent legs define an air gap.

In yet another aspect, the phased array antenna can include a ground plane and at least one dielectric layer applied adjacent to the ground plane. The substrate and array of antenna cells are formed as a current sheet array.

A method aspect is also set forth.

### BRIEF DESCRIPTION OF THE DRAWINGS

Other objects, features and advantages of the present invention will become apparent from the detailed description of the invention which follows, when considered in light of the accompanying drawings in which:

FIG. 1 is an exploded view of a wideband phased array antenna such as disclosed in the above-identified and incorporated by reference '487 patent.

FIG. 2 is a schematic top plan view of an example of the printed conductive layer of the wideband phased array antenna similar to that shown in FIG. 1.

FIG. 3 is a fragmentary, isometric view of an antenna cell formed on a substrate and showing beam former components and no metallic member positioned at each antenna cell to eliminate scan blindness.

FIG. 4 is another fragmentary, isometric view similar to FIG. 3 but showing a member as a vertically extending metallic rib member positioned at each antenna unit cell between each of the dipole antenna elements in each polarization to eliminate scan blindness without substantially reducing array gain created by cavity effects.

FIG. 5 is another fragmentary, isometric view of an antenna cell but showing vertically extending pins used to eliminate scan blindness.

FIG. 6 is a graph showing the predicted swept gain for the current sheet array with and without rib members.

FIG. 7 is another graph similar to the graph shown in FIG. 6 but showing the predicted swept gain for the current sheet array with and without pins.

### DETAILED DESCRIPTION OF THE PREFERRED EMBODIMENTS

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art. Like numbers refer to like elements throughout.

In accordance with a non-limiting example of the present invention, scan blindness can be eliminated in the larger array lattices used for dual-polarized current sheet arrays. It has been determined that scan blindness is interdependent upon the array lattice, element feed implementation, and dielectric layers Narrow vertical members, such as formed as metallic ribs or pins, can be positioned between the coupled elements in both polarizations to eliminate scan blindness without degrading the broadside (non-scanned) gain of the array. The ribs or pins extend vertically from the antenna ground plane to an optimal height that may be above or below the array element layer. This height is determined by the frequency of the scan blindness. It is important to note that one skilled in the art may try to utilize an E-plane fence or wall to eliminate scan blindness for arrays with lattice sizes greater than one-half a wavelength as described herein. This method is explained in detail in the technical literature [see references] and applies strictly to singularly-polarized dipole arrays. However, if this method is applied to dual-polarized arrays, an unavoidable cavity will be formed behind each array element. The presence of this cavity will degrade the broadside (non-scanned) gain of the array and thus eliminates this method for suppressing scan blindness for a dual-polarized array.

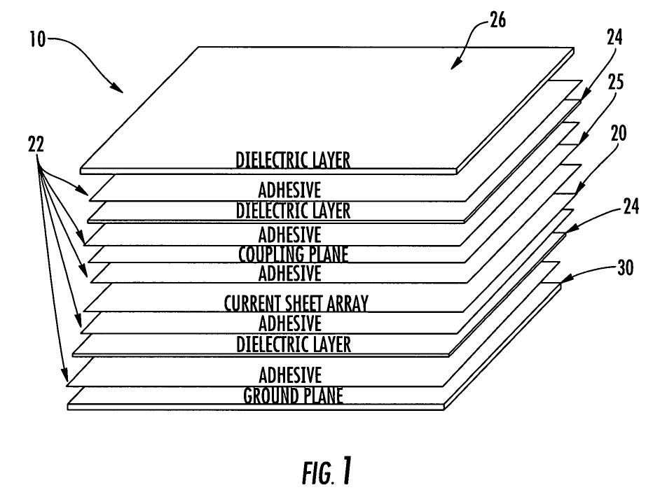

Referring now to FIG. 1, there are illustrated details of a multilayer, capacitive coupling structure and phased array antenna such as disclosed in the incorporated by reference '487 patent, are now set forth as background to understand better the phased array antenna in accordance with a non-limiting example of the present invention. Another similar patent is disclosed in U.S. Pat. No. 6,822,616, the disclosure which is hereby incorporated by reference in its entirety.

A wideband phased array antenna 10 is illustrated. The antenna 10 may be mounted on a nose cone or other rigid mounting member having either a planar or a non-planar three-dimensional shape, for example, an aircraft or spacecraft, and may also be connected to a transmission and reception controller (not shown) as would be appreciated by one skilled in the art.

The wideband phased array antenna 10 is preferably formed of a plurality of flexible layers. These layers include a dipole layer 20 or current sheet array, which is sandwiched between a ground plane 30 and an outer dielectric layer 26, such as an outer dielectric layer formed of foam. Other dielectric layers 24 (preferably made of foam or similar material) may be provided in between, as illustrated. Additionally, the phased array antenna 10 includes at least one coupling plane 25. It should be understood that the coupling plane can be embodied in many different forms, including coupling planes that are fully or partially metallized, coupling planes that reside above or below the dipole layer 20, or multiple coupling planes that can reside either above or below the dipole layer or both.

Respective adhesive layers 22 secure the dipole layer 20, ground plane 30, coupling plane 25, and dielectric layers of foam 24, 26 together to form the flexible and conformal antenna 10. Techniques for securing the layers together may also be used, as would be understood by one skilled in the art. The dielectric layers 24, 26 may have tapered dielectric constants to improve the scan angle. The dielectric layer 24 between the ground plane 30 and the dipole layer 20 may have a dielectric constant of 3.0 and the dielectric layer 24 on the opposite side of the dipole layer 20 may have a dielectric constant of 1.7, and the outer dielectric layer 26 may have a dielectric constant of 1.2 in a non-limiting example.

The current sheet array (CSA) or dipole layer has typically closely-coupled, dipole elements embedded in dielectric layers above a ground plane. Inter-element coupling in these prior art examples is achieved with interdigital capacitors. In this prior art example, the necessary degree of inter-element coupling can be maintained by placing coupling plates on separate layers around or adjacent to the interdigital capacitors. The use of coupling plates on separate layers has also been found to improve bandwidth in designs where no interdigital capacitors are used.

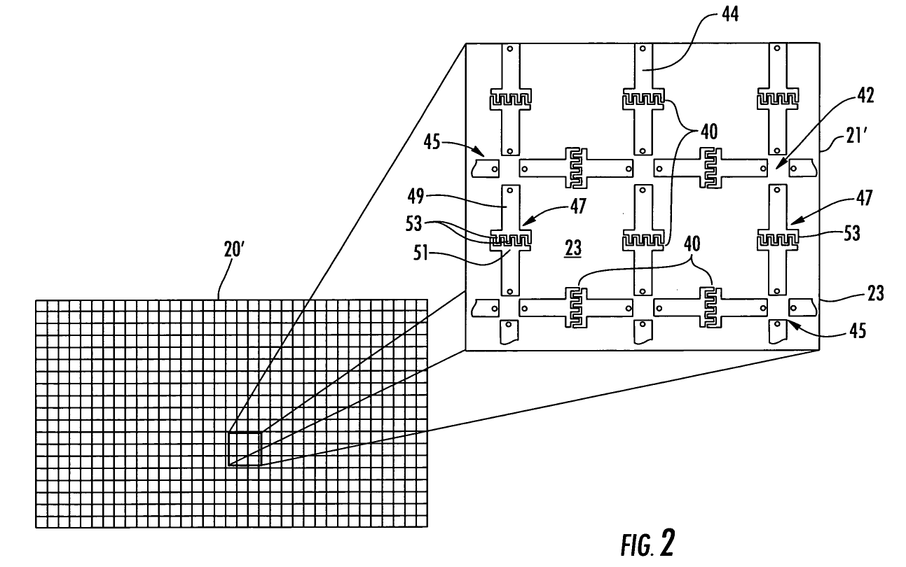

Referring now to FIG. 2, the dipole layer 20 in this example is now described. The dipole layer 20 can be formed as a printed conductive layer as an array of dipole antenna elements 40 on a flexible substrate 23. Each dipole antenna element 40 includes a medial feed portion 42 and a pair of legs 44, extending outwardly therefrom. In this example, first and second sets of coupled dipole elements form an antenna unit cell 45. Dipole antenna elements are orthogonal to each other providing dual polarization. Respective feed lines are connected to each feed portion 42 from an opposite side of the substrate 23. Adjacent legs 44 of adjacent dipole antenna elements 40 have respective spaced-apart end portions 46 to provide increased capacitive coupling between the adjacent dipole antenna elements. The adjacent dipole antenna elements 40 have predetermined shapes and are positioned relative to each other to provide an increased capacitive coupling. For example, the capacitance between adjacent dipole antenna elements 40 may be between about 0.016 and 0.636 picofarads (pF), and preferably between about 0.159 and 0.239 pF in this prior art example.

The spaced apart end portions 46 of adjacent legs 44 can have overlapping or interdigitated portions 47. Each leg 44 includes an elongated body portion 49, an enlarged width end portion 51 connected to an end of the elongated body portion, and a plurality of fingers 53, for example four fingers extending outwardly from the enlarged width end portion.

Coupling planes can be positioned adjacent to the dipole antenna elements, preferably above or below the dipole layer 20. The coupling planes can have metallization on the entire surface of the coupling plane or selected portions of the coupling plane. Of course, other arrangements that increase the capacitive coupling between the adjacent dipole antenna elements are possible.

The array of dipole antenna elements 40 can be arranged at a density in the range of about 100 to about 900 per square foot. The array of dipole antenna elements 40 can be sized and positioned so that the wideband phased array antenna 10 is operable over a frequency range of about 2 to about 30 GHz, and at a scan angle of about ±60 degrees (low scan loss). The antenna may also have a 10:1 or greater bandwidth. It could include a conformal surface mounting and be easy to manufacture at a low cost, while maintaining lightweight characteristics.

The wideband phased array antenna 10 has a desired frequency range of about 2 GHz to about 18 GHz, and the spacing between the end portions 46 of adjacent legs 44 is typically less than about one-half a wavelength at the highest desired frequency.

FIG. 2 shows first and second sets of dipole antenna elements 40 as orthogonal to each other to provide dual polarization, as would be appreciated by one skilled in the art. An array of dipole antenna elements 40 can be formed on the flexible substrate 23 such as by printing and/or etching a conductive layer of dipole antenna elements 40 on the substrate 23.

Each dipole antenna element 40 includes a medial feed portion 42 and a pair of legs 44 extending outwardly therefrom. It is possible to shape and position respective spaced apart end portions 46 of adjacent legs 44 and provide increased capacitive coupling between the adjacent dipole antenna elements. The ground plane 30 is preferably formed adjacent the array of dipole antenna elements 40, and one or more dielectric layers 24, 26 are layered on both sides of the dipole layer 20 with adhesive layers 22 therebetween.

This type of antenna 10 can be electronically scanned using a beam former, and each antenna dipole element 40 has a wide beam width. The layout of the elements 40 could be adjusted on the flexible substrate 23 or printed circuit board, or the beam former may be used to adjust the path lengths of the elements to place them in phase.

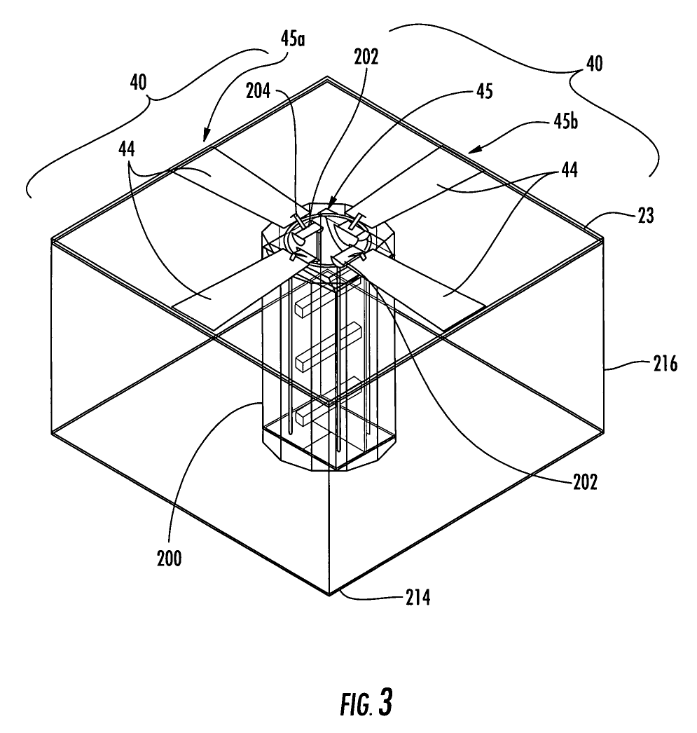

Referring now to FIG. 3, there is illustrated a fragmentary, isometric view of an antenna unit cell 45 formed on the substrate 23 such as explained relative to FIGS. 1 and 2. Each antenna unit cell 45 is formed as first and second sets 45a, 45b of coupled dipole antenna elements 40 that are orthogonal to each other and provide dual polarization. Antenna feed-line components 200 typically comprised of strip-line (as shown) or coaxial cable are illustrated positioned below the substrate 23 and form the feed point 42. Four legs 44 are illustrated and four feed point junction members 202 that are connected by a conductive strip 204 or other connector member to the legs 44. The beam former will connect to the feed-line components 200 below the ground layer 214 and will include all the electronic components used in phased array antennas as the beam former component for each antenna unit cell 45.

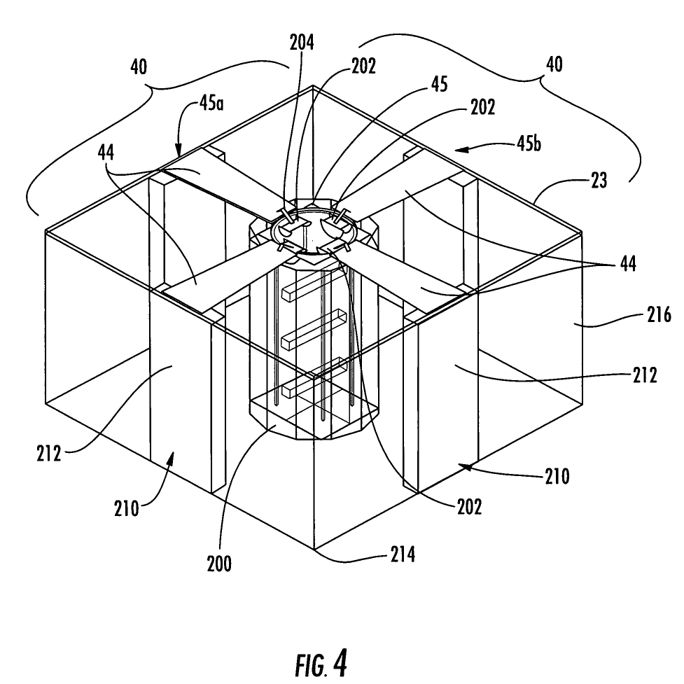

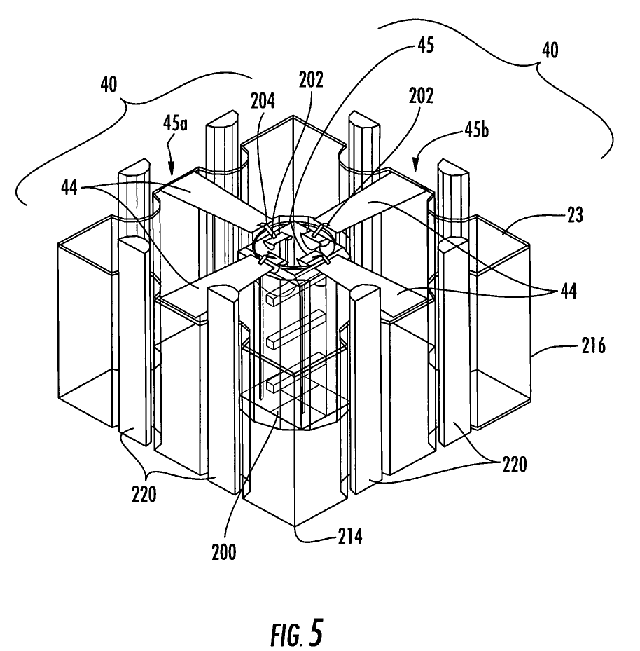

FIG. 4 is another perspective, isometric view similar to FIG. 3, but showing the metallic member 210 positioned at each antenna unit cell 45 between each of the dipole antenna elements 40 in each polarization to eliminate scan blindness without substantially reducing array gain which would be created by placing a cavity behind each unit cell. In that embodiment shown in FIG. 5, each metallic member 210 is formed as vertically extending rib member 212. The rib member 212 extends from the ground plane layer 214 through any intervening dielectric layers 216 to the substrate 23 as illustrated. Although the various dielectric layers and ground plane are not shown in detail, the FIG. 5 shows the basic components relative to the antenna unit cells. The metallic member can be formed of many different materials, including sintered or cast materials. It can be formed from magnetic materials or compositions of materials that exhibit the qualities to minimize scan blindness. Hybrid plastic with metallic fill is encompassed by this definition. Materials that exhibit metallic properties are covered by the term metallic.

FIG. 5 is another fragmentary, isometric view similar to FIG. 4 but showing the metallic member 210 formed as vertically extending pins 220 that are arranged in complementary pairs at the end portion of each leg. Although a single configuration of pins are illustrated in FIG. 5, different configurations can be used. The configuration shown in FIG. 5 includes a flat side pin with a somewhat rounded front edge that includes planar faces.

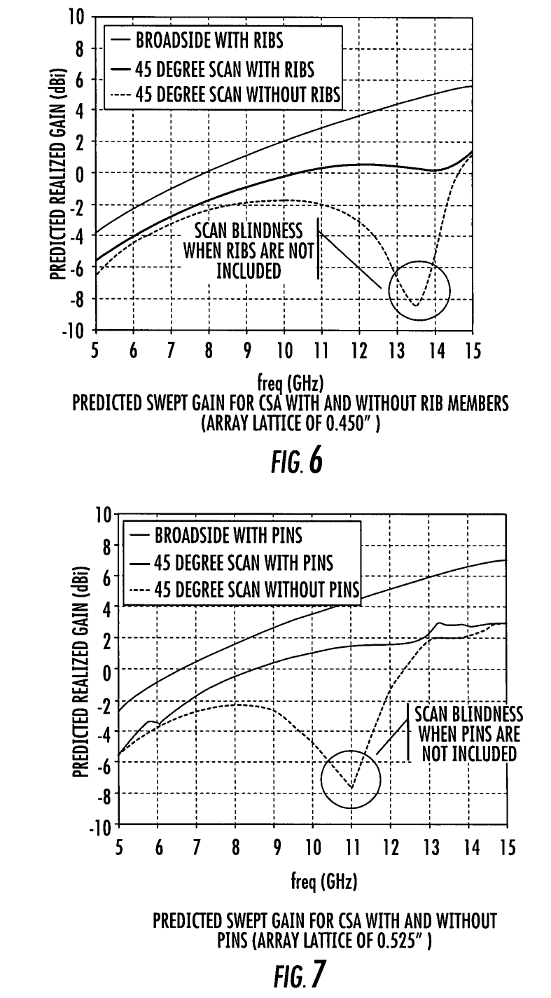

FIGS. 6 and 7 are graphs for the predicted swept gain for the current sheet array with and without the rib members as shown in FIG. 6 and the pins as shown in FIG. 7. The array lattice is 0.450″ in FIG. 6 and 0.525″ in FIG. 7. FIG. 6 shows the scan blindness when the rib members are not included at 13.5 GHz, while FIG. 7 shows the scan blindness at 11 GHz when the pins are not included.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A phased array antenna, comprising:
a substrate;
an array of antenna unit cells formed on the substrate, each antenna unit cell comprising first and second sets of coupled dipole antenna elements that are orthogonal to each other and providing dual polarization; and
a vertical member positioned at each antenna unit cell between each of the dipole antenna elements in each polarization to eliminate scan blindness.

2. The phased array antenna according to claim 1, wherein each member comprises a vertically extending rib member.

3. The phased array antenna according to claim 1, wherein each member comprises a vertically extending pin.

4. The phased array antenna according to claim 3, wherein said vertically extending pins are arranged in complementary pairs.

5. The phased array antenna according to claim 1, wherein said substrate is segmented into a plurality of array tiles and each antenna cell is positioned on a respective one of said array tiles.

6. The phased array antenna according to claim 1, wherein each dipole antenna element comprises a medial feed portion and a pair of legs extending outwardly therefrom.

7. The phased array antenna according to claim 6, wherein adjacent legs of adjacent dipole antenna elements comprise respective spaced apart end portions forming a gap between respective end portions.

8. The phased array antenna according to claim 7, wherein respective spaced apart end portions of adjacent legs define an air gap.

9. A phased array antenna, comprising:
a ground plane;
at least one dielectric layer applied adjacent the ground plane;
a substrate and array of antenna unit cells thereon, each antenna unit cell comprising first and second sets of coupled dipole antenna elements that are orthogonal to each other and providing dual polarization, each dipole antenna element comprising a medial feed portion and a pair of legs extending outwardly therefrom; and
a metallic member positioned at each antenna unit cell between each of the dipole antenna elements in each polarization and extending from the ground plane to an optimal height which may be above or below the array element layer to eliminate scan blindness.

10. The phased array antenna according to claim 9, wherein each metallic member comprises a vertically extending rib member positioned at an end of each leg.

11. The phased array antenna according to claim 9, wherein each metallic member comprises a vertically extending pin positioned at an end of each leg.

12. The phased array antenna according to claim 11, wherein said vertically extending pins are arranged in complementary pairs on opposing sides of a leg.

13. The phased array antenna according to claim 9, wherein said substrate is segmented into a plurality of array tiles and each antenna cell positioned on a respective one of said array tiles.

14. The phased array antenna according to claim 9, wherein adjacent legs of adjacent dipole antenna elements comprise respective spaced apart end portions forming a gap between respective end portions.

15. The phased array antenna according to claim 14, wherein respective spaced apart end portions of adjacent legs define an air gap.

16. The phased array antenna according to claim 15, wherein each metallic member is positioned at an end portion adjacent the air gap.

17. A method of forming a phased array antenna comprising:
providing a substrate;
forming an array of antenna unit cells on the substrate, each antenna unit cell comprising first and second sets of coupled dipole antenna elements that are orthogonal to each other and providing dual polarization; and
forming a metallic member at each antenna unit cell between each of the dipole antenna elements at each polarization to eliminate scan blindness.

18. The method according to claim 17, which further comprises forming each metallic member as a vertically extending rib member.

19. The method according to claim 17, which further comprises forming each metallic member as a vertically extending pin.

20. The method according to claim 19, which further comprises arranging pins in complementary pairs.

21. The method according to claim 17, which further comprises forming the substrate and plurality of antenna dipole antenna elements as a current sheet array.
